(19) United States
(12) Patent Application Publication
(10) Pub. No.: US 2023/0316472 A1
(43) Pub. Date: Oct. 5, 2023

(54) IMAGE LIGHTNESS ADJUSTMENT METHOD

(71) Applicant: HONDA MOTOR CO., LTD., Tokyo (JP)

(72) Inventor: Seiya SHIRAKAWA, Tokyo (JP)

(21) Appl. No.: 18/189,282

(22) Filed: Mar. 24, 2023

(30) Foreign Application Priority Data
Mar. 31, 2022 (JP) 2022-058319

(51) Int. Cl. G06T 5/40; G06T 7/00

(52) U.S. Cl. CPC G06T 5/40; G06T 7/0002; G06T 2207/20021; G06T 2207/30168; G06T 2207/30108

(57) ABSTRACT

In an image lightness adjustment method, a first histogram H1 is generated from image data in accordance with a lightness value, the first histogram H1 is shifted for average lightness A1 in the first histogram H1 to have a predetermined lightness value B, and the first histogram H1 is divided into a second histogram H2 on a lower lightness side and a third histogram H3 on a higher lightness side. After the second histogram H2 and the third histogram H3 are respectively enlarged at predetermined magnification ratios to generate a fourth histogram H4 and a fifth histogram H5 respectively including lightness values within a minimum lightness value and a maximum lightness value, the fourth histogram H4 and the fifth histogram H5 are synthesized to obtain a sixth histogram H6. The lightness value of the image data is adjusted, based on the sixth histogram H6.

### BACKGROUND

### Technical Field

The present invention relates to an image lightness adjustment method for adjusting lightness of an image displayed on a display device.

### Related Art

In binarization of a display image, conventionally, there is a method for flattening a histogram as a method for adjusting lightness and contrast of an image in a conventional technique.

In JP 2016-126750 A, in order to improve the visibility of an image, an image is divided into a plurality of regions in accordance with a designated division condition, and the transmittance of light in each divided region is calculated. The contrast of each divided region is adjusted in accordance with information of the transmittance of light.

In JP 2009-219140 A, in order to process an image to be a visually natural image, exposure is changed for an identical scene to acquire a plurality of color image series. In such a plurality of color image series, out of the plurality of color images in a certain image position, an image that is low in appearance frequency of a color is determined to be an image having appropriate exposure in such an image position.

In JP 2003-179809 A, in order to prevent degradation of an output image, a lightness histogram is compared and analyzed for every predetermined threshold, and the lightness histogram is corrected to be smooth as a whole. As a result, the lightness distribution in a state of backlight, whitening, or blackening of a subject is corrected.

### SUMMARY

In processing, for example, an inspection image for inspecting a component, however, it is not necessary to convert the inspection image into an image that looks visually natural. Rather than that, it is necessary to convert the inspection image into an image that makes it easy to distinguish between a normal product and an abnormal product. In this case, in the above-described methods, there are drawbacks that it is insufficient to suppress an occurrence of overexposure or blackening, and even though the overexposure or blackening does not occur, it is insufficient to determine a part to be extracted (an abnormal part or the like) in the inspection.

The present invention has an object to provide an image lightness adjustment method for adjusting a lightness value of an image so as to facilitate determination of a part to be extracted in an image, in binarization of the image.

In order to achieve the above object, according to a first aspect, an image lightness adjustment method includes: generating a first histogram (H1 in the present embodiment (hereinafter, the same will apply)) from image data in accordance with a lightness value; shifting the first histogram for average lightness (A1) in the first histogram to have a predetermined lightness value (B); dividing the first histogram into a second histogram (H2) and a third histogram (H3) having a lightness value larger than a lightness value of the second histogram with the predetermined lightness value as a reference; enlarging the second histogram at a first predetermined magnification ratio (m1) on a smaller side of the lightness value to obtain a fourth histogram (H4) including the lightness value equal to or larger than a minimum lightness value (Lmin); enlarging the third histogram at a second predetermined magnification ratio (m2) on a larger side of the lightness value to obtain a fifth histogram (H5) including the lightness value equal to or smaller than a maximum lightness value (Lmax); synthesizing the fourth histogram and the fifth histogram to obtain a sixth histogram (H6); and adjusting the lightness value of the image data, based on the sixth histogram.

In this manner, after the first histogram is shifted so that the average lightness becomes the predetermined lightness value, the first histogram is divided into the second histogram on a lower lightness side and the third histogram on a higher lightness side, and the second histogram and the third histogram are enlarged. Here, the fourth histogram includes lightness values equal to or larger than the minimum lightness value, and the fifth histogram includes lightness values equal to or smaller than the maximum lightness value. Therefore, overexposure or blackening does not occur. In addition, the sixth histogram becomes a widely distributed histogram between the minimum lightness value and the maximum lightness value, and becomes an image in which a part to be extracted in the image is easily clarified. Therefore, in binarization of an image, it is possible to provide an image lightness adjustment method for adjusting the lightness values in the image so as to facilitate determination of a part to be extracted in the image.

According to a second aspect of the present invention, in the image lightness adjustment method described in the first aspect, the predetermined lightness value is an average value of the minimum lightness value and the maximum lightness value.

In this manner, in the case where the predetermined lightness value is the average value of the minimum lightness value and the maximum lightness value, the sixth histogram finally obtained is generated with the average value as a reference.

Accordingly, the sixth histogram becomes a widely distributed histogram between the minimum lightness value and the maximum lightness value.

According to a third aspect of the present invention, in the image lightness adjustment method described in the first aspect, the predetermined lightness value is a preset value.

In this manner, in the case where the predetermined lightness value is a preset value, the sixth histogram finally obtained is generated with such a preset value as a reference. In this case, for example, in a case where the lightness value of the part to be extracted in the image is known, the sixth histogram can be a widely distributed histogram with the lightness value of the part as a reference.

According to a fourth aspect of the present invention, in the image lightness adjustment method described in the first aspect, the minimum lightness value denotes a minimum value of possible lightness values, and the maximum lightness value denotes a maximum value of possible lightness values.

In this manner, in the case where the minimum lightness value is set to the minimum value of the possible lightness values, and the maximum lightness value is set to the maximum value of the possible lightness values, the sixth histogram can be a histogram distributed as widely as possible in accordance with the possible lightness values.

According to a fifth aspect of the present invention, in the image lightness adjustment method described in the first aspect, either one of the minimum lightness value or the maximum lightness value is a preset value, or both the minimum lightness value and the maximum lightness value are preset values.

In this manner, either one of the minimum lightness value or the maximum lightness value is a set value, or both of them are set values. For example, in a case where the sixth histogram is preferably created within a predetermined lightness value range, preferable image data can be obtained.

### BRIEF DESCRIPTION OF DRAWINGS

FIG. 1 is a schematic diagram illustrating a configuration of an inspection device;

FIG. 2 is a diagram illustrating an example of a first histogram;

FIG. 3 is a diagram for describing shifting of the first histogram;

FIG. 4 is a diagram for describing a second histogram and a third histogram;

FIG. 5 is a diagram for describing enlarging of the second histogram and a fourth histogram;

FIG. 6 is a diagram for describing enlarging of a third histogram and a fifth histogram;

FIG. 7 is a diagram for describing a sixth histogram; and

FIG. 8 is a flowchart for describing a schematic procedure of an image lightness adjustment operation.

### DETAILED DESCRIPTION

Hereinafter, an image lightness adjustment method according to the present embodiment will be described with reference to the drawings. In the present embodiment, a description will be given assuming that the image lightness adjustment method is applied to an inspection device 1, which carries out an inspection to identify two classes. The inspection device 1 is a device for carrying out an inspection to identify a normal product and an abnormal product of a manufactured product. Specifically, the inspection device 1 inspects whether image data to be inspected belongs to normal image data or abnormal image data. Note that, in the following description, even though a description is given as an “image”, “image data” that can be controlled by the control unit is indicated, in some cases.

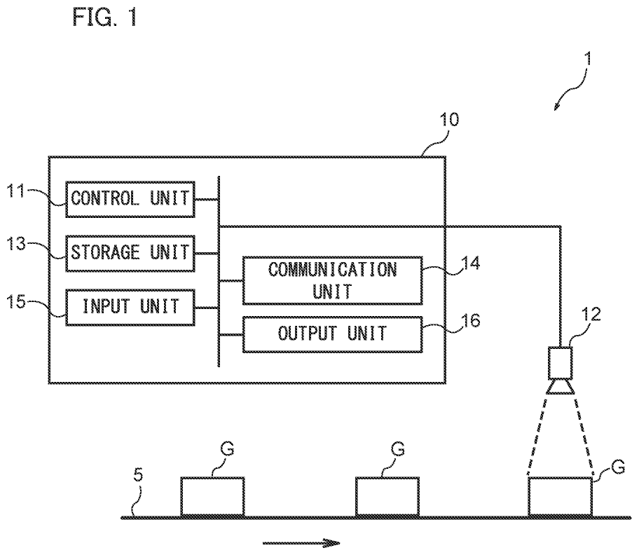

FIG. 1 is a schematic diagram illustrating a configuration of the inspection device 1. As illustrated in FIG. 1, the inspection device 1, which uses the image lightness adjustment method in the present embodiment, inspects an inspected product G, which is to be inspected and conveyed on a conveyance unit 5. The inspection device 1 inspects the inspected product G, and carries out an inspection of whether the inspected product G is a normal product (non-defective product) that satisfies a predetermined quality or an abnormal product (defective product) that does not satisfy the predetermined quality. The inspection device 1 includes a control unit 11, an imaging unit 12, a storage unit 13, a communication unit 14, an input unit 15, and an output unit 16. These units may be disposed in an information processing device 10 such as a computer, or may be configured to be communicable. They are connected by communication cables or wirelessly so as to exchange information with one another.

The control unit 11 includes a central processing unit (CPU), and controls an operation of each unit of the inspection device 1. The control unit 11 conducts control, by executing a program stored in the storage unit 13 or a main storage unit, not illustrated, in the control unit 11.

The imaging unit 12 includes a camera or the like. In the present embodiment, the inspected product G conveyed by the conveyance unit 5 is imaged, and obtained image data is transmitted to the information processing device 10. Note that in FIG. 1, an example in which one camera is disposed is given. However, the present invention is not limited to this. It may be configured that a plurality of cameras are disposed and the inspected product G is imaged from a plurality of angles.

The storage unit 13 denotes generally a device for storage including a random access memory (RAM) and a read only memory (ROM). In addition to the program executed by the control unit 11 and the image data acquired by the imaging unit 12, data necessary for the inspection by the inspection device 1, such as data that has been learned by a neural network, is stored in the storage unit 13. Note that FIG. 1 illustrates an example in which the storage unit 13 is disposed in the information processing device 10. However, the present invention is not limited to this. A part or the entirety of the storage unit 13 may be disposed outside the information processing device 10, or may be configured to be communicable with the information processing device 10 through the Internet.

The communication unit 14 is a unit for communication between the information processing device 10 and an external device. In a case where the imaging unit 12, the storage unit 13, the input unit 15, and the output unit 16 are disposed outside the information processing device 10, the communication unit 14 communicates with the control unit 11 in the information processing device 10 by using a known technology of a wireless communication line or the like.

The input unit 15 is a unit on which a user or the like of the inspection device 1 inputs data into the information processing device 10, and includes a keyboard, a mouse, or the like. The user is able to input image data related to the inspection, an instruction to the control unit 11, or the like from the input unit 15. The inspection device 1 includes the input unit 15, so that the user is able to input settings of lightness values to be described later by using the input unit 15.

The output unit 16 is a unit for outputting information about the inspection, and denotes generally a unit for outputting information in the information processing device 10, and includes an image display unit such as a display, a sound output unit such as a speaker, or an output terminal for outputting data. By displaying image data related to image processing in the inspection device 1, the output unit 16 is capable of displaying an image related to the inspection for the user. In addition, the output unit 16 may display a histogram to be described later. Next, the image lightness adjustment method in the present embodiment will be specifically described with reference to the drawings.

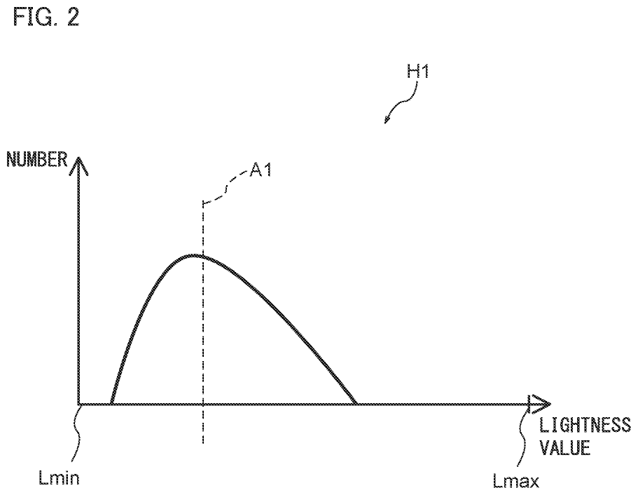

FIG. 2 is a diagram illustrating an example of a first histogram H1. In the present embodiment, the first histogram H1 is generated in accordance with a lightness value from the image data obtained by the imaging unit 12 or the image data stored in the storage unit 13. In the following histograms, the horizontal axis represents the lightness value, and the vertical axis represents the frequency (for example, the number of pixels) of the lightness value. The control unit 11 generates or processes the histogram. For the sake of description, the histograms of FIG. 2 and subsequent figures do not represent a specific number of pixels in detail, and schematically represent the number of pixels.

In the present embodiment, an example in which the first histogram H1 deviates to a darker side (smaller in the lightness value, on the left side in FIG. 2) relative to the average of the entire lightness values is illustrated, without being limited to this. In addition, FIG. 2 also illustrates average lightness A1, which serves as a reference of the first histogram H1. A calculation method of the average lightness A1 is to calculate an average value of the lightness values of the pixels that constitute the first histogram H1. Note that the value that serves as the reference denotes a reference value for use in shifting of the first histogram H1 to be described later. However, the reference value may be any value other than the average lightness A1.

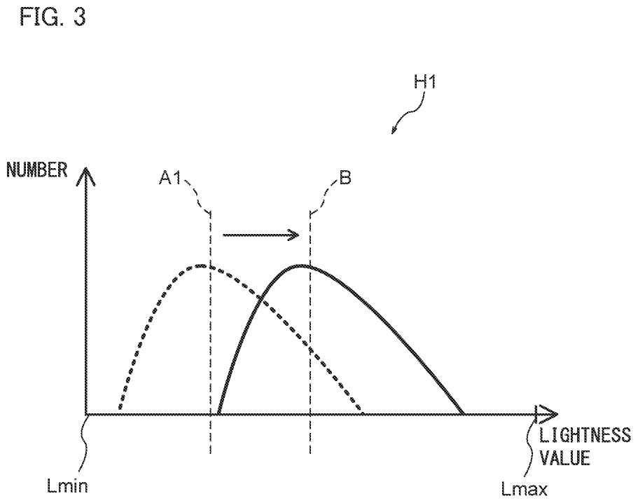

FIG. 3 is a diagram for describing shifting of the first histogram H1. As illustrated in FIG. 3, the first histogram H1 is shifted so that the average lightness Al in the first histogram H1 becomes a predetermined lightness value B. Accordingly, the first histogram H1 moves rightward from the position of the broken line to the position of the solid line in the drawing.

Here, a predetermined lightness value B in the present embodiment is an average value of a minimum lightness value Lmin and a maximum lightness value Lmax. In addition, the minimum lightness value Lmin in the present embodiment denotes a minimum value of possible lightness values, and the maximum lightness value Lmax denotes a maximum value of possible lightness values. For example, in a case of an 8-bit image, the minimum lightness value is 0, and the maximum lightness value is 255. Note that the predetermined lightness value B may be a set value. In addition, either one of the minimum lightness value Lmin or the maximum lightness value Lmax may be a preset value, or both of them may be preset values. When making the settings, the user or the like may use the input unit 15 for the settings.

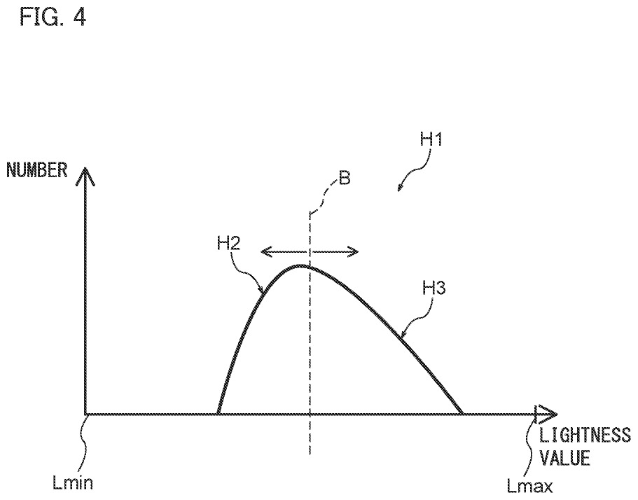

FIG. 4 is a diagram illustrating a second histogram H2 and a third histogram H3. As illustrated in FIG. 4, the first histogram H1 moved in FIG. 3 is divided into the second histogram H2 on a lower lightness side and the third histogram H3 on a higher lightness side, with the predetermined lightness value B as a reference. In this manner, the first histogram H1 is divided into the second histogram H2 and the third histogram H3 having lightness values larger than those of the second histogram H2, with the predetermined lightness value B as a reference.

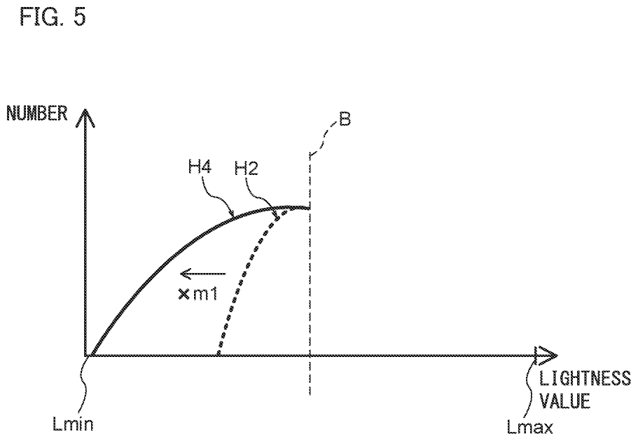

FIG. 5 is a diagram illustrating enlarging of the second histogram H2 and a fourth histogram H4. As illustrated in FIG. 5, the second histogram H2 is enlarged at a first predetermined magnification ratio m1 toward a smaller lightness value side. Specifically, the standard deviation is adjusted to obtain the histogram as illustrated in FIG. 5. Accordingly, the fourth histogram H4 is obtained. Here, the first predetermined magnification ratio m1 is set such that all elements that constitute the fourth histogram H4 include lightness values equal to or larger than the minimum lightness value Lmin. Note that the first predetermined magnification ratio m1 may be set by the user, or may be automatically set. In addition, the first predetermined magnification ratio m1 does not have to be a preset value, and may be gradually increased while being calculated, until the minimum value of the fourth histogram H4 reaches the minimum lightness value Lmin.

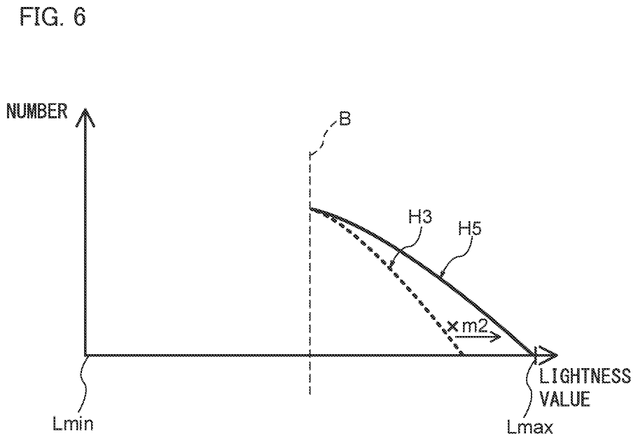

FIG. 6 is a diagram illustrating enlarging of the third histogram H3 and a fifth histogram H5. As illustrated in FIG. 6, the third histogram H3 is enlarged at a second predetermined magnification ratio m2 toward a larger lightness value side. Specifically, the standard deviation is adjusted to obtain the histogram as illustrated in FIG. 6. Accordingly, the fifth histogram H5 is obtained. Here, the second predetermined magnification ratio m2 is set such that all elements that constitute the fifth histogram H5 include lightness values equal to or smaller than the maximum lightness value Lmax. Note that the second predetermined magnification ratio m2 may be set by the user, or may be automatically set. In addition, the second predetermined magnification ratio m2 does not have to be a preset value, and may be gradually increased while being calculated, until the maximum value of the fifth histogram H5 reaches the maximum lightness value Lmax.

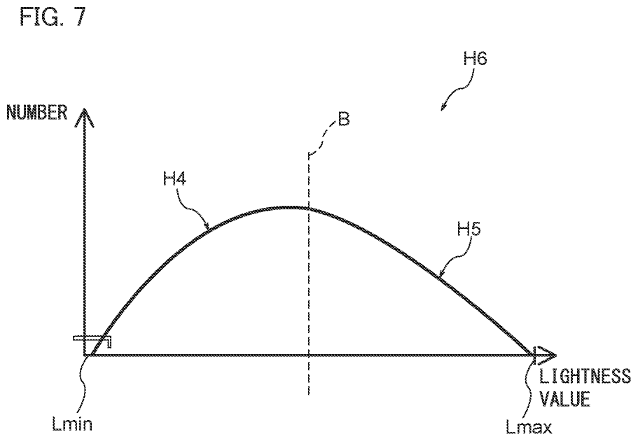

FIG. 7 is a diagram illustrating a sixth histogram H6. As illustrated in FIG. 7, the sixth histogram H6 can be obtained by synthesizing the fourth histogram H4 obtained in FIG. 5 and the fifth histogram H5 obtained in FIG. 6. By adjusting the lightness value of the image data, based on the sixth histogram H6, a suitable image in the inspection by the inspection device 1 can be obtained.

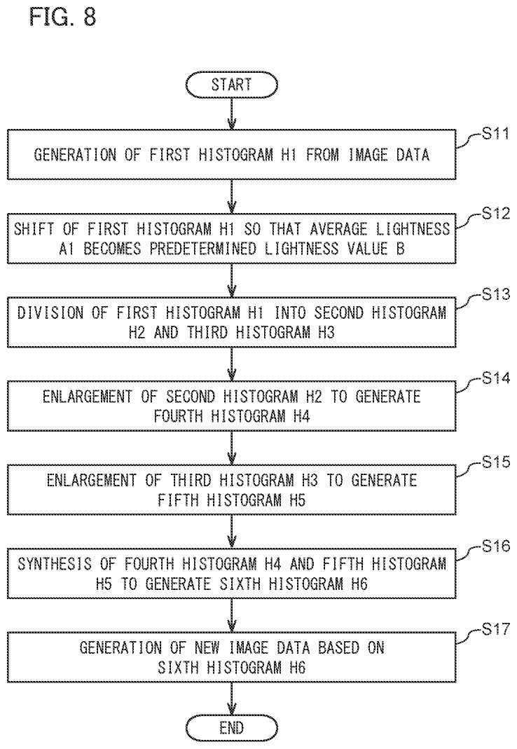

FIG. 8 is a flowchart illustrating a schematic procedure of an image lightness adjustment operation. For example, the CPU of the control unit 11 performs the processing illustrated in the flowchart of FIG. 8, while developing a program stored in the ROM of the storage unit 13 in the RAM or the like.

In step S11, the first histogram H1 corresponding to the lightness value is generated from the image data. In step S12, the first histogram H1 is shifted so that the average lightness A1 in the first histogram becomes the predetermined lightness value B. In step S13, the first histogram H1 is divided into the second histogram H2 and the third histogram H3 with the predetermined lightness value B as a reference.

In step S14, the second histogram H2 is enlarged on the smaller lightness value side, and the fourth histogram H4 including lightness values equal to or larger than the minimum lightness value Lmin is generated. In step S15, the third histogram H3 is enlarged on the larger lightness value side, and the fifth histogram H5 including lightness values equal to or smaller than the maximum lightness value Lmax is generated.

In step S16, the fourth histogram H4 and the fifth histogram H5 are synthesized to generate the sixth histogram H6. In step S17, the lightness value of the image data is adjusted, based on the sixth histogram H6, and new image data is generated.

As described heretofore, according to the present embodiment, after the first histogram H1 is shifted so that the average lightness A1 becomes the predetermined lightness value B, the first histogram H1 is divided into the second histogram H2 on the lower lightness side and the third histogram H3 on the higher lightness side, and the second histogram H2 and the third histogram H3 are enlarged. Here, the fourth histogram H4 includes lightness values equal to or larger than the minimum lightness value, and the fifth histogram H5 includes lightness values equal to or smaller than the maximum lightness value. Therefore, overexposure or blackening does not occur. In addition, the sixth histogram H6 becomes a widely distributed histogram between the minimum lightness value and the maximum lightness value, and an image in which a part to be extracted in the image is easily clarified is obtained. Therefore, in binarization of an image, it is possible to provide an image lightness adjustment method for adjusting the lightness values in the image so as to facilitate determination of a part to be extracted in the image.

In addition, according to the present embodiment, in a case where the predetermined lightness value B is an average value of the minimum lightness value Lmin and the maximum lightness value Lmax, the sixth histogram H6 to be finally obtained is generated with the average value as a reference. Accordingly, the sixth histogram H6 becomes a widely distributed histogram between the minimum lightness value and the maximum lightness value.

Further, in the present embodiment, in a case where the predetermined lightness value B is a preset value, the sixth histogram H6 to be finally obtained is generated with the set value as a reference. In this case, for example, in a case where the lightness value of the part to be extracted in the image is known, the sixth histogram H6 can be a widely distributed histogram with the lightness value of the part as a reference.

In addition, in the present embodiment, in a case where the minimum lightness value Lmin is set to the minimum value of the possible lightness values and the maximum lightness value Lmax is set to the maximum value of the possible lightness values, the sixth histogram H6 can be a histogram distributed as widely as possible in accordance with the possible lightness values.

Further, in the present embodiment, either one of the minimum lightness value Lmin or the maximum lightness value Lmax is a set value, or both of them are set values. For example, in a case where the sixth histogram H6 is preferably created within a predetermined lightness value range, preferable image data can be obtained.

By using the image lightness adjustment method as described heretofore, in a case where the average lightness values of the image data are equalized and the threshold of the lightness value is set, a wide distribution can be obtained from the lower limit to the upper limit of the threshold. Therefore, an image suitable for the inspection is obtained.

Note that the present invention is not limited to the embodiments that have been described, and may be implemented in various modes. In addition, it is also achievable in processing to be performed by the processor of the control unit reading and executing the program for implementing the respective units in the above-described embodiments.

What is claimed is:

1. An image lightness adjustment method comprising:
generating a first histogram from image data in accordance with a lightness value;
shifting the first histogram for average lightness in the first histogram to have a predetermined lightness value;
dividing the first histogram into a second histogram and a third histogram having a lightness value larger than a lightness value of the second histogram with the predetermined lightness value as a reference;
enlarging the second histogram at a first predetermined magnification ratio on a smaller side of the lightness value to obtain a fourth histogram including the lightness value equal to or larger than a minimum lightness value;
enlarging the third histogram at a second predetermined magnification ratio on a larger side of the lightness value to obtain a fifth histogram including the lightness value equal to or smaller than a maximum lightness value;
synthesizing the fourth histogram and the fifth histogram to obtain a sixth histogram; and
adjusting the lightness value of the image data, based on the sixth histogram.

2. The image lightness adjustment method according to claim 1, wherein the predetermined lightness value is an average value of the minimum lightness value and the maximum lightness value.

3. The image lightness adjustment method according to claim 1, wherein the predetermined lightness value is a preset value.

4. The image lightness adjustment method according to claim 1, wherein the minimum lightness value denotes a minimum value of possible lightness values, and
the maximum lightness value denotes a maximum value of possible lightness values.

5. The image lightness adjustment method according to claim 1, wherein either one of the minimum lightness value or the maximum lightness value is a preset value, or both the minimum lightness value and the maximum lightness value are preset values.
